(19) United States
(12) Patent Application Publication
(10) Pub. No.: US 2004/0047267 A1
(43) Pub. Date: Mar. 11, 2004

(54) Disc loading tray

(76) Inventors: Chun-Hung Chen, Taipei Hsien (TW); Chih-Chung Lai, Taipei Hsien (TW); Chia-Hsin Hsieh, Taipei Hsien (TW)

Correspondence Address: Michael D. Bednarek, SHAWPITTMAN, 1650 Tysons Boulevard, McLean, VA, 22102-4859, US

(21) Appl. No.: 10/435,265

(22) Filed: May 12, 2003

(30) Foreign Application Priority Data
Sep. 11, 2002 (TW) 091214292

(51) Int. Cl. G11B 33/02

(52) U.S. Cl. 369/75.2

(57) ABSTRACT

A disc loading tray arranged to receive either a recordable disc or a reproducible disc is disclosed. The disc loading tray is arranged with an disc receiving recess having an inner side surface with a bevel positioned thereon. The bevel is formed by retreating the inner side surface inwards with respect to a rotating axis of the disc loading tray by an inclination. Such a configuration of the disc loading tray is sufficient to stabilize an airflow field circulating through the disc loading tray.

### FIELD OF THE INVENTION

The present invention is related to a disc loading tray, and more particularly, the present invention is related to a disc loading tray capable of altering the airflow field generated due to the rotation of a disc medium received therein, and lowering the motor temperature of an optical disc drive.

### BACKGROUND OF THE INVENTION

Ascribing to the widespread distribution of optical disc media (which is popularly known as compact disc, CD), the development of desktop optical disc drive is an ongoing objective that promotes the production of various types of CD-disc drives. The optical disc drive, including CD-ROM, CD-RW and DVD-ROM, has its corresponding optical disc medium to be accessed thereby. An optical disc medium follows a clockwise orientation to rotate inside an optical disc drive during operation regardless the type of optical disc medium. However, when the optical disc medium is rotating in a high speed inside an optical disc drive, it will cause an unpleasant vibration and noise which disturb the user acutely.

For example, desktop CD-ROM today is generally classified into two types depending on the manner of how the compact disc is loaded into the CD-ROM, one is called slot-in type and the other one is called tray-type. A common tray-type CD-ROM is typically constructed from an optical pick-up device (also known as an optical pick-up head or read head), a motor and a disc loading tray 10 which is shown in FIG. 1. While the CD-ROM desires to access the data contained in an optical disc medium, which may be a recordable disc or a reproducible disc, a motor will drive the optical pick-up device to perform data read/write operation to the optical disc medium received in the disc loading tray 10.

Referring to FIGS. 1 and 2, the structure of the disc loading tray of a tray-type CD-ROM according to the conventional art is illustrated. The disc loading tray as shown in FIG. 1 is generally provided with a disc receiving recess 110 that allows a compact disc to be received therein. Disc receiving recess 110 includes an inner side surface 112. Because disc loading tray 10 is commonly manufactured by a plastic molding injection process or a press-pleating process, it is a preferable way to use the cross-sectional view of the manufacturing molds as shown in FIG. 2 to depict the profile of the inner side surface of the disc receiving recess 110.

As shown in FIG. 2, the disc receiving recess 110 of the disc loading tray 10 is shaped inside a space defined by a female mold 210 and a male mold 220, which are used in combination to form the contour of the inner side surface 112 of the disc receiving recess 110. Because the press-fit surface of the female mold 210 forms the front face, i.e. the outlining face of the disc loading tray 10, normally the ejector pin that is used to eject the disc loading tray is placed inside the male mold 220 in the consideration of an aesthetic point of view. In this way, it will not leave traces of ejection point and deckle edge on the front face of the disc loading tray 10.

The major problems encountered in the conventional desktop CD-ROM are concluded with two annoying factors, one is a heat-dissipating issue and the other one comes from vibration and noise, both of which are associated with the airflow field arising from the rotation of the optical disc medium located within an optical disc drive. Referring to FIGS. 3a and 3b, the resultant airflow field as the compact disc is rotating inside a CD-ROM is shown. The compact disc rotates clockwise with respect to the rotating axis 60 as shown in FIG. 3a, and thus the airflow will be split by the inner side surface 112 of the disc receiving recess 110 to circulate over and beneath the tray 10 while the airflow is circulating therethrough, which will be interfered with the inner side surface 112 mutually and cause turbulence. This accommodates a poor heat-convection effect and the heat within the CD-ROM can not be dissipated effectively. Further, the airflow field will be interfered and become unstable due to the turbulence, and vibration and noise will succeed.

In view thereof, a primary object of the development and design of the desktop CD-ROM is stressed on the deformation of the profile of the inner side surface of the disc loading tray, i.e. to alter and stabilize the airflow field circulating through the disc loading tray. The present invention can meet these needs.

### SUMMARY OF THE INVENTION

In view of the foregoing, an object of the present invention is focused on the provision of a disc loading tray which is made by deforming the profile of an inner side surface of a prior art disc loading tray, in order to compel an airflow circulating therethrough caused by the rotation of a disc medium to be stabilized through the influence of the disc loading tray. The operation of a disc medium can become stable by using the disc loading tray according to the present invention, and the heat-dissipating effect of an optical disc drive using the disc loading tray of the present invention can be improved. Moreover, the motor temperature of an optical disc drive can be maintained at a low magnitude through the use of the disc loading tray according to the present invention, and vibration and noise generated during operation can be abated.

The present invention discloses a disc loading tray for receiving a disc medium. The disc loading tray of the present invention is provided with a disc receiving recess having an inner side surface, wherein the inner side surface includes a bevel positioned with respect to an axial direction of the disc loading tray so as to stabilize an airflow circulating through the disc loading tray. According to a broader sense of the present invention, the bevel is formed by retreating the inner side surface inwards with respect to an axial direction by an inclination.

An alternative viewpoint of the present invention is directed to a disc loading tray for receiving a disc medium. The disc loading tray of the present invention is provided with a disc receiving recess having an inner side surface, wherein the inner side surface includes a bevel formed by retreating the inner side surface inwards with respect to the axial direction by an inclination so as to stabilize an airflow circulating through the disc loading tray.

Another aspect of the present invention is concerned with a contrivance of a disc drive apparatus including an optical pick-up device which accesses data recorded on a disc medium, a motor which drives the optical pick-up device, and a disc loading tray for receiving the disc medium and including a disc receiving recess having an inner side surface, wherein the inner side surface includes a bevel positioned with respect to an axial direction of the disc loading tray so as to guide an airflow circulating through the disc loading tray to the motor. According to a broader sense of the present invention, the bevel is formed by retreating the inner side surface inwards with respect to the axial direction by an inclination.

In a preferred embodiment of the present invention, the disc medium is either a recordable disc or a reproducible disc.

The features and benefits of the present invention can be best understood by way of the following descriptions of preferred embodiments and accompanied drawings, in which:

### BRIEF DESCRIPTION OF THE DRAWINGS

FIG. 1 shows an outline view of a disc loading tray according to the prior art;

FIG. 2 shows a profile of a disc loading tray and manufacturing molds used in the manufacturing process of the disc loading tray according to the prior art;

FIG. 3a shows an airflow field circulating through a prior art disc loading tray;

FIG. 3b is a schematic diagram illustrating the impact of a circulating airflow on a prior art disc loading tray;

FIG. 4 shows the profile of a disc loading tray and manufacturing molds used the manufacturing process of the disc loading tray according to a preferred embodiment of the present invention;

FIG. 5 is a schematic diagram illustrating the impact of a circulating airflow on a disc loading tray according to the present invention; and

FIG. 6 characteristically shows the relationship between motor temperature and motor revolution while the disc loading tray of the present invention is functioning in an optical disc drive.

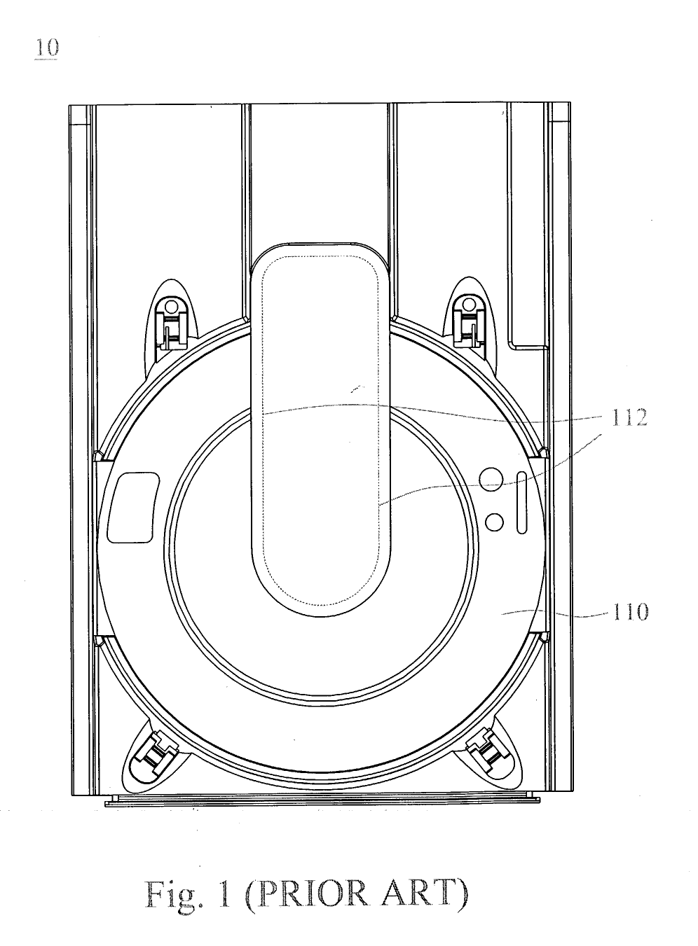

### DETAILED DESCRIPTION OF THE PREFERRED EMBODIMENTS

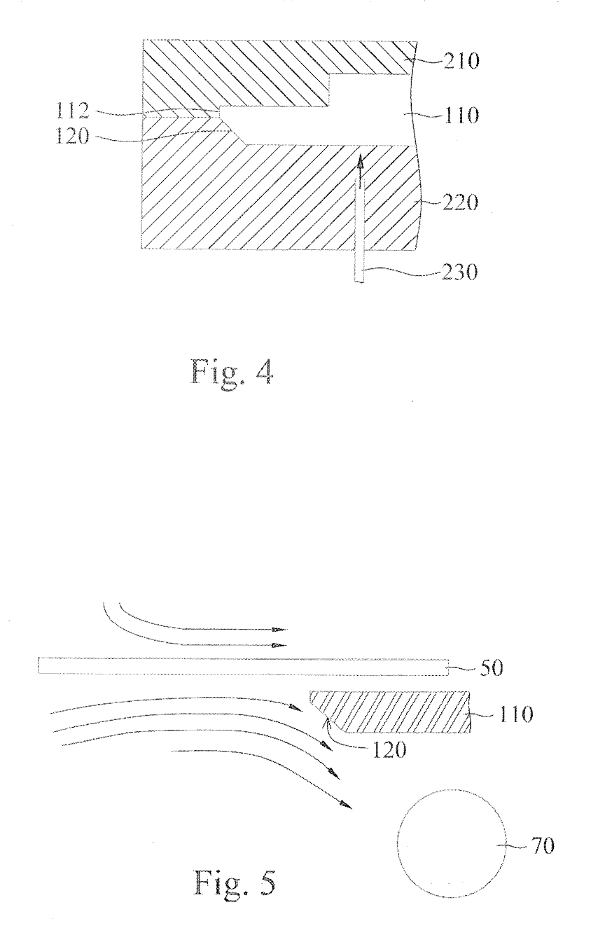

A preferred embodiment incorporating the features of the disc loading tray according to the principle of the present invention is depicted in FIG. 4 in conjunction with the following descriptions.

Referring to FIG. 4, a disc loading tray disclosed herein is used to load a disc media, for example, a recordable disc or a reproducible disc. The configuration of the disc loading tray of the present invention may be understood in reference to the disc loading tray 10 of FIG. 4, which includes a disc receiving recess 110 having an inner side surface 112.

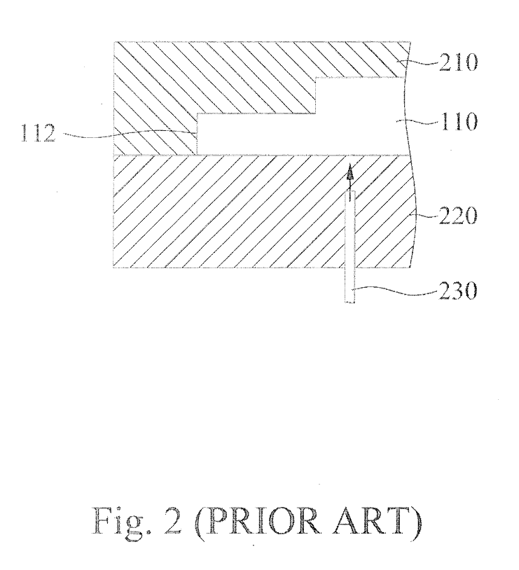

The shape and profile of the inner side surface 112 of the disc receiving recess 110 is depicted with reference to FIG. 4. As similar to FIG. 2, the disc receiving recess 110 of the disc loading tray 10 as shown in FIG. 4 in accordance with the present invention is shaped inside a space defined by a female mode 210 and a male mold 220, which are used in combination to form the contour of the inner side surface 112 of the disc receiving recess 110. Also an ejector pin 230 which is used to eject the disc loading tray is placed inside the locations of the male mold 220, so that the front face, i.e. the outlining face of the disc loading tray will not be more nice-looking without the trace of ejection point and deckle edge. However, the present invention is distinguished over the conventional art by that the present invention incorporates a bevel 120 positioned on the inner side surface 112 of the disc receiving recess 110 with respect to an axial direction of the disc loading tray.

The purpose of bevel 120 is to stabilize the airflow field circulating through the disc loading tray. More specifically, the bevel 120 can be formed by retreating the inner side surface 112 inwards with respect to an axial direction of the disc loading tray by an inclination.

Turning to FIG. 5, the influence on the airflow field circulating through the disc loading tray 10 caused by the disc loading tray 10 of the present invention will be demonstrated in greater detail.

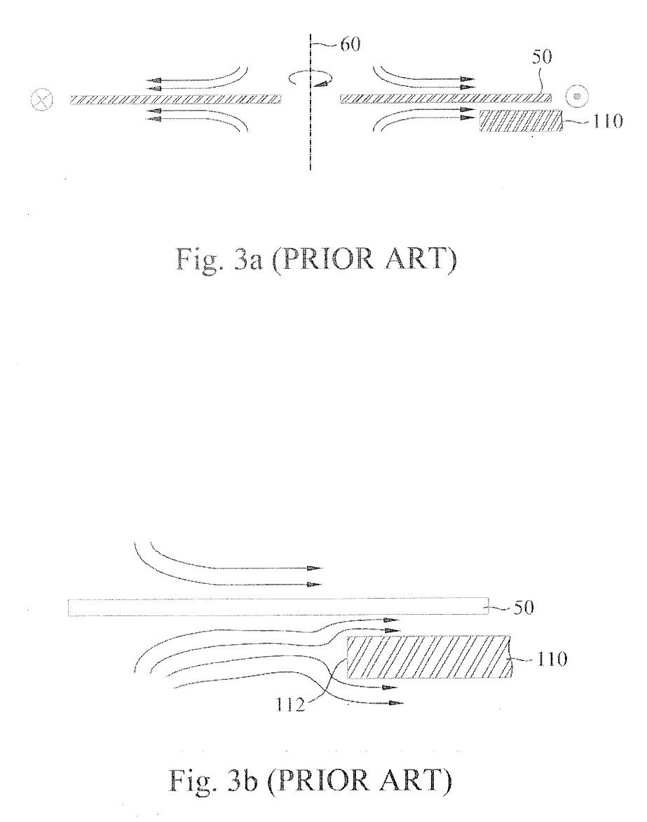

As shown in FIG. 3(b), it can be seen that because the conventional disc loading tray of a CD-ROM does not provide a bevel on its inner side surface, an airflow that circulates through the disc loading tray will be split into tributary airflows flowing through a top surface and a bottom surface of the disc loading tray due to the profile of the inner side surface of the disc receiving recess as airflow circulating through the disc loading tray, and the tributary airflows will mutually interfere with the inner side surface of the disc receiving recess and turbulence is induced accordingly. However, since the disc loading tray according to the present invention establishes a bevel on an inner side surface 112 of a disc receiving recess 110 thereof, the airflow circulating through the disc loading tray 10 can be diverted to result in a stabilized airflow, and noise and vibration generated during the rotating operation of disc loading tray 10 can be suppressed. Further, the profile of the disc loading tray of the present invention is further capable of guiding an airflow circulating therethrough to a direction pointing at a motor 70 to enhance the heat-dissipating effect of the motor 70 by a convection operation. The motor temperature can thus be maintained at a lower magnitude and the degradation of the electrical characteristics of the motor 70 can be downscaled to obtain a better data reading and writing quality.

It is needed to explain here that the disc receiving recess 110 shown in FIGS. 4 and 5 is taken as an example to illustrate the position of the bevel 120 in this preferred embodiment. However, the position of the bevel 120 is not compulsorily required to be located at the part of the disc receiving recess 110. In other words, the bevel 120 can be positioned at any place of the inner side surface of any member of the disc loading tray 10 with respect to an axial direction of the disc loading tray 10. In this configuration, the shape of the bevel 120 can be formed by retreating the inner side surface of the disc loading tray 10 inwards as similar to that stated above, and the function and utility of the bevel 120 are alike as compared with the aforementioned.

It can be readily understood that the disc loading tray of the present invention can be further extended to be adapted for a disc drive apparatus, for example, a CD-ROM. More concretely, the disc drive apparatus includes an optical pick-up device, a motor, and a disc loading tray as described above. The motor is used to drive the optical pick-up device, and the disc loading tray is used to receive a disc medium.

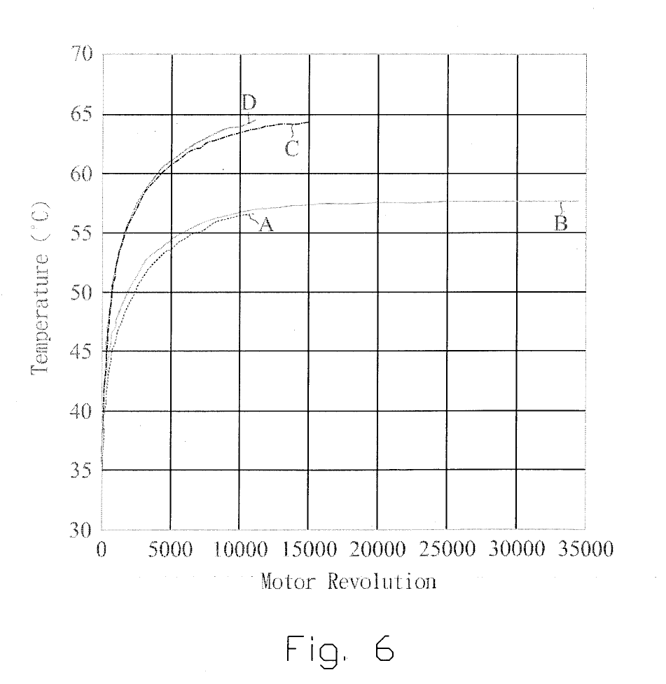

The heat-dissipating effect obtained by using the disc loading tray of the present invention will be discussed as follows. FIG. 6 characteristically shows the reciprocal relationship between the motor revolution and motor temperature. In the curve diagram of FIG. 6, the transverse axis stands for motor revolution, and the longitudinal axis stands for motor temperature. In FIG. 6, curve A is derived from the case with a tray-type CD-RW disc drive using the disc loading tray of the present invention, curve B is derived from the case with a tray-type CD-RW disc drive using the conventional disc loading tray, and curve C is derived from the case with a tray-type CD-ROM disc drive using the conventional disc loading tray. It can be readily realized from the reciprocal relationship between the motor revolution and motor temperature as revealed in FIG. 6 that when the motor revolution exceeds 10000 and tends toward stability, the motor temperature of the optical disc drive using the disc loading tray of the present invention will be lowered down to about 56° C. to 57° C. Compared to an optical disc drive using a conventional disc loading tray, the motor temperature can be lowered by about 8° C. according to the present invention. In this manner, the present invention indeed can contribute the betterment of the airflow field stemming from the rotation of the disc medium, and the motor can be operated under a lower temperature and maintain a great quality.

Although the present invention has been described and illustrated in detail, it is to be clearly understood that the same is by the way of illustration and example only and is not to be taken by way of limitation, the spirit and scope of the present invention being limited only by the terms of the appended claims.

What is claimed is:

1. A disc loading tray for receiving a disc medium including a disc receiving recess having an inner side surface, wherein the inner side surface includes a bevel positioned with respect to an axial direction of the disc loading tray so as to stabilize an airflow circulating through the disc loading tray.

2. The disc loading tray according to claim 1 wherein the bevel is formed in a way by retreating the inner side surface inwards with respect to the axial direction by an inclination.

3. The disc loading tray according to claim 1 wherein the disc medium is a recordable disc.

4. The disc loading tray according to claim 1 wherein the disc medium is a reproducible disc.

5. A disc loading tray for receiving a disc medium including a disc receiving recess having an inner side surface, wherein the inner side surface includes a bevel positioned with respect to an axial direction of the disc loading tray, and the bevel is formed in a way by retreating the inner side surface inwards with respect to the axial direction by an inclination, so as to stabilize an airflow circulating through the disc loading tray.

6. The disc loading tray according to claim 5 wherein the disc medium is a recordable disc.

7. The disc loading tray according to claim 5 wherein the disc medium is a reproducible disc.

8. A disc drive apparatus comprising:
an optical pick-up device which accesses data recorded on a disc medium;
a motor which drives the optical pick-up device; and
a disc loading tray for receiving the disc medium and including a disc receiving recess having an inner side surface, wherein the inner side surface includes a bevel positioned with respect to an axial direction of the disc loading tray so as to guide an airflow circulating through the disc loading tray to the motor.

9. The disc drive apparatus according to claim 8 wherein the bevel is formed by retreating the inner side surface inwards with respect to the axial direction by an inclination.

10. The disc loading tray according to claim 8 wherein the disc medium is a recordable disc.

11. The disc loading tray according to claim 8 wherein the disc medium is a reproducible disc.
